(19) United States
(12) Patent Application Publication
(10) Pub. No.: US 2004/0197589 A1
(43) Pub. Date: Oct. 7, 2004

(54) Transparent biaxially oriented polyolefin film with improved sealing qualities

(76) Inventors: Detlef Busch, Saarlouis (DE); Joachim Jung, Neunkirchen (DE)

Correspondence Address: Connolly Bove, Lodge & Hutz, 1220 Market Street, PO Box 2207, Wilmington, DE, 19899, US

(21) Appl. No.: 10/484,597

(22) PCT Filed: Jul. 30, 2002
(86) PCT No.: PCT/EP02/08470

(30) Foreign Application Priority Data
Aug. 1, 2001 (DE) 101 37 584.0

(51) Int. Cl. B32B 27/32

(52) U.S. Cl. 428/515; 428/523

(57) ABSTRACT

The invention relates to the use of a pololyfin film for scaling purposes. The film consists of a base layer which is made of polyolefin polymers and at least one outer covering layer. The covering layer contains at least 50 wt. % of a polyolefin modified by maleic acid anhydride, in relation to the weight of the covering layer, and undergoes flame surface treatment on the surface of said covering layer.

The surface tension of polyolefin films is increased using plasma, flame and corona treatment. The films thereby become printable and wettable with water-based coating systems. Whereas corona treatment is employed for heat-sealable and non-heat-sealable films, flame treatment is principally used for non-heat-sealable films.

In the flame treatment of non-heat-sealable films, the film is transported over a chill roll, above which a gas burner is arranged. The separation between burner and film surface/chill roll is selected in such a way that the oxidation reactions on the polymer surface are maximized. Oxidized polar groups are formed in the process, increasing the surface tension of the film in the desired manner.

It is taught to carry out the treatment of non-heat-sealable films at a chill-roll temperature of greater than 36° C. (cf. “The base flame treatment process”, H. Angeli/Esse Ci, 3rd International Meeting on the Plastic Surface Treatment, 1989, Narni, Italy). Below this temperature, water vapour condensation occurs on the film surface, making the film unusable.

Compared with corona treatment, the flame treatment of non-heat-sealable films has advantages. These are a high and time-constant surface tension, low odour of the film and no occurrence of the reverse-side effect. A disadvantage is the very high thermal load on the film surface.

The prior art discloses heat-sealable films. These heat-sealable films generally have top layers comprising copolymers or terpolymers of propylene, ethylene and/or butylene units. These films are sensitive to thermal load and are damaged during flame treatment in such a way that they lose their heat-sealability. The use of the process described above for these heat-sealable films is therefore not practicable. The thermal load on the heat-sealable surface is too high, and a reduction in the chill-roll temperature results in the water vapour condensation described.

In the case of heat-sealable films, it is therefore taught to use flame treatment with polarization (cf. “The polarized flame process”, H. Lori/Esse Ci, 3rd International Meeting on the Plastic Surface Treatment, 1989, Narni, Italy). In this method, the burner is arranged above the chill roll. A direct voltage is applied between the burner and the chill roll, causing the ionized atoms in the flame to achieve increased acceleration and to hit the polymer surface with greater kinetic energy. The chemical bonds within the polymer molecules are broken more easily, and free-radical formation proceeds more quickly. The thermal load on the polymer surface is lower than in the case of flame treatment without polarization. At the same flame temperature, a higher surface tension is achieved in the process with polarization than in the process without polarization. In other words, a lower flame temperature is required in order to achieve the same surface tension in the process with polarization than in the process without polarization, resulting in protection of the heat-sealing layer.

EP 0 732 188 describes a further process for the flame treatment of heat-sealable films. In this process, a flame is likewise employed without polarization, and the film is cooled considerably on the roll. The temperature of the flame-treated film surface here after leaving the chill roll is at most 25° C. This process has the disadvantage that the temperature programme for the films is restricted and additional cooling devices are required.

The prior art discloses processes for improving adhesion properties of polyolefin films, in particular polypropylene films. These films are usually plasma-, flame- or corona-treated on one or both surfaces during production. These processes increase the surface tension of the film and improve, for example, its printability, metallizability or adhesion to other coatings.

The disadvantage of these known processes is that the increased surface tension drops continuously after the film has been produced. By the time the film is processed, the surface tension has frequently dropped so much that a further surface treatment must be carried out before printing, metallization or other corresponding processing steps in order to ensure the desired good adhesive strength. With the subsequent treatment, however, the original values are no longer achieved. Correspondingly, the adhesion properties of these films or the adhesion properties achieved by these processes are in need of improvement.

The object of the present invention was therefore to provide a polyolefin film which is distinguished by particularly good heat-sealing properties. In particular, it is necessary here that the heat-sealable surface can be flame-treated in order to increase the surface tension without impairing the heat-sealability. The film should be economical and inexpensive to produce. The other service properties required, in particular gloss and haze in the case of transparent embodiments, of the film should not be impaired in the process.

This object is achieved through the use of a polyolefin film for heat-sealing, where the film comprises a base layer built up from polyolefinic polymers and at least one outer top layer, where this top layer comprises at least 50% by weight, based on the weight of the top layer, of a maleic anhydride-modified polyolefin and has been surface-treated by means of a flame on the surface of the said top layer.

In accordance with the invention, the film comprises at least one base layer and a top layer which forms an outer layer of the film. In general, the top layer is applied to one surface of the base layer. If desired, a further top layer of any desired type can be applied to the opposite surface of the base layer. In this way, three-layered embodiments with a flame-treated and heat-sealable top layer are obtained. If desired, these three-layered embodiments can be modified by additional interlayers between the base layer and the outer top layers. In this way, four- and five-layered embodiments of the film according to the invention are obtained. All embodiments have in common the feature which is essential to the invention, that at least one top layer is built up from a maleic anhydride-modified polyolefin and has been flame-treated, but nevertheless remains heat-sealable.

This top layer of the film generally comprises at least 50% by weight, preferably from 80 to 100% by weight, in particular from 95 to <100% by weight, in each case based on the layer, of a maleic anhydride-modified polyolefin, referred to as MAPO below. In addition to the MAPO, further constituents of the top layer can be polyolefinic polymers built up from ethylene, propylene or butylene units. These polyolefins are present in an amount of from 0 to 50% by weight, preferably from 0 to 20% by weight, in particular from >0 to 5% by weight, in each case based on the top layer. For the purposes of clear differentiation from the modified polyolefins, these unmodified polyolefins which are additionally present in the top layer as mixture component are referred to below as polyolefin II. If desired, the top layer additionally comprises conventional additives in effective amounts in each case.

Polyolefins II are, for example, polyethylenes, polypropylenes, polybutylenes or copolymers of olefins having from two to eight carbon atoms, of which polyethylenes and polypropylenes are preferred. Polypropylenes are homopolymers comprising propylene units or copolymers, which also includes terpolymers, which are built up predominantly from propylene units; they generally comprise at least 50% by weight, preferably from 70 to 99% by weight, of propylene units, based on the propylene copolymer.

In general, the propylene polymer comprises at least 90% by weight, preferably from 94 to 100% by weight, of propylene units. The corresponding comonomer content of at most 10% by weight or from 0 to 6% by weight respectively generally consists, if present, of ethylene and butylene. The data in % by weight are in each case based on the propylene homopolymer.

If desired, the polyolefin II employed can be isotactic propylene homopolymers having a melting point of from 140 to 170° C., preferably from 155 to 165° C., and a melt flow index (measurement DIN 53 735 at a load of 21.6 N and 230° C.) of from 1.0 to 10 g/10 min, preferably from 1.5 to 6.5 g/10 min. The n-heptane-soluble content of the isotactic propylene homopolymers is generally from 1 to 10% by weight, preferably 2-5% by weight, based on the starting polymer.

The polyolefins II employed in the top layer together with the MAPO are preferably copolymers or terpolymers, preferably copolymers of ethylene and propylene or ethylene and butylene or propylene and butylene or terpolymers of ethylene and propylene and butylene, or mixtures of two or more of the said copolymers and terpolymers.

In particular, the polyolefin II are random ethylene-propylene copolymers having an ethylene content of from 1 to 10% by weight or random propylene-1-butylene copolymers having a butylene content of from 2 to 25% by weight, in each case based on the total weight of the copolymer, or random ethylene-propylene-1-butylene terpolymers having an ethylene content of from 1 to 10% by weight and a 1-butylene content of from 2 to 20% by weight, in each case based on the total weight of the terpolymer, or a blend of ethylene-propylene-1-butylene terpolymers and propylene-1-butylene copolymers, where the blend has an ethylene content of from 0.1 to 7% by weight, a propylene content of from 50 to 90% by weight and a 1-butylene content of from 10 to 40% by weight, in each case based on the total weight of the polymer blend.

The above-described copolymers and/or terpolymers employed in the top layer generally have a melt flow index of from 1.5 to 30 g/10 min, preferably from 3 to 15 g/10 min. The melting point is in the range from 120 to 140° C. The above-described blend of copolymers and terpolymers has a melt flow index of from 5 to 9 g/10 min and a melting point of from 120 to 150° C. All melt flow indices indicated above are measured at 230° C. and a force of 21.6 N (DIN 53 735).

The molecular weight distribution of the above-described polyolefins II can vary in broad limits depending on the area of application. The ratio between the weight average molecular weight M_{w} and the number average molecular weight Mₙ is generally between 1 and 15, preferably in the range from 2 to 10. A molecular weight distribution of this type is achieved, for example, by peroxidic degradation or by preparation of the polyolefin by means of suitable metallocene catalysts.

Maleic anhydride-modified polyolefins are polyolefins which are hydrophilized through the incorporation of maleic acid units. These modified polyolefins are known per se in the prior art and are also known as crafted polymers. The modification is carried out by reaction of the polyolefins with maleic anhydride by suitable processing steps. These processes are also known per se in the prior art.

The base polyolefins used for the reaction with maleic anhydride can in principle be the above-described polyolefins II, where, for the purposes of the present invention, propylene homopolymers or propylene copolymers or propylene terpolymers built up predominantly from propylene units generally comprising at least 50% by weight, preferably from 70 to 99% by weight, of propylene units, based on the propylene copolymer, are preferred as base polymers for the modification. The preparation of these maleic anhydride-modified polypropylenes is known per se in the prior art and is described, for example, in U.S. Pat. No. 3,433,777 and U.S. Pat. No. 4,198,327.

The density, in accordance with ASTM D 1505, of the modified polyolefins, preferably modified propylene polymers, is preferably in the range from 0.89 to 0.92 g/cm³, in particular 0.9 g/cm³, the Vicat softening point in accordance with ASTM 1525 is in a range of from 120 to 150° C., in particular from 140 to 145° C., the Shore hardness in accordance with ASTM 2240 is from 55 to 70, preferably 67° C., and the melting point in accordance with ASTM D 2117 is in a range of from 140 to 165° C., preferably from 150 to 165° C., in particular from 155 to 160° C. The maleic acid content in the modified polyolefin, preferably propylene polymer, is generally less than 5%, based on the modified polyolefin, preferably in the range from 0.05 to 3%, in particular from 0.1 to 1%. The melt flow index of the modified polyolefin, preferably polypropylene, is generally from 1 to 20 g/10 min, preferably from 3 to 10 g/10 min.

The following propylene polymers are preferably employed for the modification with maleic anhydride:

Isotactic propylene homopolymers having a melting point of from 140 to 170° C., preferably from 155 to 165° C., and a melt flow index (measurement DIN 53 735 at a load of 21.6 N and 230° C.) of from 1.0 to 10 g/10 min, preferably from 1.5 to 6.5 g/10 min, are employed. The n-heptane-soluble content of the isotactic propylene homopolymers is generally from 1 to 10% by weight, preferably 2-5% by weight, based on the starting polymer.

Copolymers of ethylene and propylene or propylene and butylene or terpolymers of ethylene and propylene and butylene or mixtures of two or more of the said copolymers and terpolymers.

Particular preference is given to random ethylene-propylene copolymers having an ethylene content of from 1 to 10% by weight or random propylene-1-butylene copolymers having a butylene content of from 2 to 25% by weight, in each case based on the total weight of the copolymer, or random ethylene-propylene-1-butylene terpolymers having an ethylene content of from 1 to 10% by weight and a 1-butylene content of from 2 to 20% by weight, in each case based on the total weight of the terpolymer, or a blend of ethylene-propylene-1-butylene terpolymers and propylene-1-butylene copolymers, where the blend has an ethylene content of from 0.1 to 7% by weight, a propylene content of from 50 to 90% by weight and a 1-butylene content of from 10 to 40% by weight, in each case based on the total weight of the polymer blend.

The above-described copolymers and/or terpolymers employed for the modification generally have a melt flow index of from 1.5 to 30 g/10 min, preferably from 3 to 15 g/10 min. The melting point is in the range from 120 to 140° C. The above-described blend of copolymers and terpolymers has a melt flow index of from 5 to 9 g/10 min and a melting point of from 120 to 150° C. All melt flow indices indicated above are measured at 230° C. and a force of 21.6 N (DIN 53 735).

The top layer may, if desired, additionally comprise conventional additives, such as neutralizers, stabilizers, antistatics, antiblocking agents and/or lubricants, in effective amounts in each case.

It has been found that the surface of the top layer is very highly suitable for surface treatment by means of a flame. The values achieved for the surface tension are high, preferably in the range from 37 to 50 mN/m, in particular from 39 to 45 mN/m. Surprisingly, the film still has excellent heat-sealing properties even after the corresponding flame treatment and can therefore be used in accordance with the invention for the production of heat-sealed and surface-treated packaging. This is particularly noteworthy in view of the adverse effect of flame treatment on the heat-sealability which is described in the prior art. Conventional top-layer materials which have not been modified with maleic anhydride lose their heat-sealing properties virtually completely after flame treatment.

In addition, the use of flame treatment avoids impairment of the processing properties through reverse-side effects on the opposite surface. Adverse effects of this type are known, for example, from the corona treatment of heat-sealable films. As a result, the film, owing to the flame treatment, exhibits good adhesion to printing inks, excellent heat-sealing properties and no reverse-side effects. The heat seal strengths achieved are between 0.7 and 2.5 N/15 mm (HAST 130° C., 10 N/cm², 0.5 sec.). Surprisingly, the heat seal strength after flame treatment is in the same order of magnitude as after corona treatment, i.e. the heat-sealing is not impaired by the flame treatment.

The base layer of the polyolefin film is basically built up from the above-described polyolefins II, of which preference is given to the propylene homopolymers described, in particular isotactic propylene homopolymers. In general, the base layer comprises from at least 70 to 100, preferably from 80 to <100% by weight, of polyolefin or propylene polymer. Furthermore, the base layer usually comprises neutralizers and stabilizers, and, if desired, further conventional additives in effective amounts in each case. For opaque or white-opaque embodiments of the film, the base layer additionally comprises vacuole-initiating fillers and/or pigments. The type and amount of the fillers are known in the prior art.

The thickness of the top layer comprising modified polyolefin is greater than 0.1 μm and is preferably in the range from 0.3 to 3 μm, in particular from 0.4 to 1.5 μm.

If desired, the film may have further layers, preferably a second top layer, and, if desired, interlayers on one or both sides.

The interlayer(s) may consist of the polyolefins II described and, if desired, comprise conventional additives, such as antistatics, neutralizers, lubricants and/or stabilizers, and, if desired, antiblocking agents. The thickness of the interlayer(s), if present, is greater than 0.3 10 μm and is preferably in the range from 1.0 to 15 10 μm, in particular from 1.5 to 10 μm.

The second top layer may likewise be built up from the polyolefins II described. Heat-sealable and non-heat-sealable embodiments are therefore possible for the second top layer. If desired, the top layer comprises conventional additives in a similar manner to the other layers. The thickness of this second top layer is from 0.5μ to 5 μm, preferably from 0.5 to 2.5 μm.

In a further embodiment, the second top layer may, like the first top layer, be built up from modified polyolefins and, if desired, flame-treated if increased surface tension is desired.

The total thickness of the polyolefin film according to the invention can vary within broad limits and depends on the intended use. It is preferably from 4 to 100 μm, in particular from 5 to 80 μm, preferably from 10 to 50 μm, with the base layer making up from about 40 to 98% of the total film thickness.

The invention furthermore relates to a process for the production of the polyolefin film according to the invention by the coextrusion process, which is known per se.

This process is carried out by coextruding the melts corresponding to the individual layers of the film through a flat-film die, taking off the resultant film over one or more roll(s) for solidification, subsequently stretching (orienting) the film, heat-setting the stretched film and, if desired, corona- or flame-treating the surface layer intended for the treatment.

Biaxial stretching (orientation) is carried out sequentially or simultaneously. The sequential stretching is generally carried out consecutively, with consecutive biaxial stretching, in which stretching is firstly carried out longitudinally (in the machine direction) and then transversely (perpendicular to the machine direction), being preferred. The simultaneous stretching can be carried out by the flat film process or by the blowing process. The film production is described further using the example of flat film extrusion with subsequent sequential stretching.

Firstly, as is usual in the extrusion process, the polymer or the polymer mixture of the individual layers is compressed and liquefied in an extruder, it being possible for any additives optionally added already to be present in the polymer or polymer mixture. The melts are then forced simultaneously through a flat-film die (slot die), and the extruded multilayered film is taken off over one or more take-off rolls, during which it cools and solidifies.

The film obtained in this way is then stretched longitudinally and transversely to the extrusion direction, which results in alignment of the molecule chains. The longitudinal stretching is advantageously carried out with the aid of two rolls running at different speeds corresponding to the target stretching ratio, and the transverse stretching is advantageously carried out with the aid of an appropriate tenter frame. The longitudinal stretching ratios are in the range from 4 to 8, preferably from 5 to 6. The transverse stretching ratios are in the range from 5 to 10, preferably from 7 to 9.

The stretching of the film is followed by heat-setting (heat treatment) thereof, in which the film is held at a temperature from 100 to 160° C. for from about 0.1 to 10 seconds. The film is subsequently wound up in a conventional manner by means of a wind-up device.

It has proven particularly favourable to keep the take-off roll or rolls by means of which the extruded film is cooled and solidified at a temperature from 10 to 100° C., preferably from 20 to 50° C., by means of a heating and cooling circuit.

The temperatures at which longitudinal and transverse stretching are carried out can vary in a relatively broad range and depend on the desired properties of the film. In general, the longitudinal stretching is preferably carried out at from 80 to 150° C. and the transverse stretching is preferably carried out at from 120 to 170° C.

After the biaxial stretching, the top layer comprising modified polyolefin is, in accordance with the invention, flame-treated by the method known per se. Flame treatment processes are described, for example, in EP 0732 188. The treatment intensity is generally in the range from 37 to 50 mN/m, preferably from 39 to 45 mN/m. In general, this flame treatment is carried out by means of a flame without polarization. If desired, it is also possible to employ polarized flames. During the flame treatment, the film is passed over a chill roll, with a burner being installed above this roll. This burner is generally installed at a separation of from 3 to 10 mm from the film surface/chill roll. During contact with the flame, the film surface experiences an oxidation reaction. The film is preferably cooled via the chill roll during the treatment. The roll temperature is in the range from 15 to 65° C., preferably from 20 to 50° C.

The invention is now explained with reference to a working example:

### EXAMPLE 1

A transparent three-layered film consisting of the base layer B, a first top layer A and a second top layer C with a total thickness of 30 μm was produced by coextrusion followed by stepwise orientation in the longitudinal and transverse directions. The first top layer A had a thickness of 1.0 μm and the second top layer C had a thickness of 0.7 μm. The layers had the following compositions:

Base layer C:

| | |
|---|---|
| 99.64% by weight | of propylene homopolymer having a melting point of |
| | 165° C. and a melt flow index of 3.4 g/10 min and a |
| | chain isotacticity index of 94% |
| 0.10% by weight | of erucamide (lubricant) |
| 0.10% by weight | of Armostat 300 (antistatic) |
| 0.03% by weight | of neutralizer (CaCO3) |
| 0.13% by weight | of stabilizer (Irganox) |

Top layer A:

| | |
|---|---|
| 100% by weight | of maleic anhydride-modified polypropylene having a |
| | maleic acid content of 0.1% by weight, based on the |
| | polymer |

Top layer C:

| | |
|---|---|
| 99.54% by weight | of random copolymer comprising ethylene and propyl- |
| | ene having a melt flow index of 6.0 g/10 min and an |
| | ethylene content of 6% by weight, based on the co- |
| | polymer |
| 0.22% by weight | of SiO2 as antiblocking agent having a mean particle |
| | size of 4 μm |
| 0.20% by weight | of stabilizer (Irganox 1010/Irgafos 168) |
| 0.04% by weight | of neutralizer (Ca stearate) |

The production conditions in the individual process steps were as follows:

| Extrusion: | Temperatures Base layer B: | 270° | C. |
|---|---|---|---|
| | Top layer A: | 250° | C. |
| | Top layer C: | 270° | C. |
| | Temperature of the take-off roll: | 30° | C. |
| Longitudinal stretching: | Temperature: | 100° | C. |
| | Longitudinal stretching ratio: | 1:4.5 | |
| Transverse stretching: | Temperature: | 170° | C. |
| | Transverse stretching ratio: | 1:9 | |
| Setting: | Temperature: | 140° | C. |

| | |
|---|---|
| Convergence: | 10% |

The surface of top layer A was treated by means of a flame which had a flame temperature of about 690° C. This flame was produced by burning a natural gas/air mix with a throughput of 120 m3/h.

The transverse stretching ratio of 1:9 is an effective value. This effective value is calculated from the final film width B reduced by twice the seam width b, divided by the width of the longitudinally stretched film C, likewise reduced by twice the seam width b.

Immediately after the flame treatment, the film had a surface tension of 44 mN/m on the surface of top layer A. On subsequent printing, the film exhibited very good printing-ink adhesion. It was possible to heat-seal the film under HST conditions (sealing temperature 130° C.; sealing pressure 10 N/cm2, contact time 0.5 s). The heat seal strength of an A/A seal seam was 2.0 N/15 mm.

### COMPARATIVE EXAMPLE 1

A film was produced as described in Example 1. In contrast to Example 1, the top layer A was surface-treated by means of a corona. The film likewise had good heat-sealing properties. However, the film exhibited clear reverse-side effects on the opposite surface, resulting in blocking during winding-up and optical flaws on printing of surface A.

### COMPARATIVE EXAMPLE 2

A film was produced as described in Example 1. In contrast to Example 1, an unmodified polypropylene copolymer having an ethylene content of about 5% by weight was employed in top layer A. This film exhibited very good heat-sealing properties without flame treatment. After flame treatment, the heat seal strength under identical heat-sealing conditions was only 0.8 N/15 mm.

The following measurement methods were used to characterize the raw materials and the films:

Melt Flow Index

The melt flow index was measured in accordance with DIN 53 735 at a load of 21.6 N and 230° C.

Melting Point

DSC measurement, maximum of the melting curve, heating rate 20° C./min.

Surface Tension

The surface tension was determined by the so-called ink method (DIN 53 364).

Printability

The pre-treated films were printed. The ink adhesion was assessed by means of the adhesive-tape test. If little ink was removed by means of an adhesive tape, the ink adhesion was assessed as moderate, and if a significant amount of ink was removed, it was assessed as poor.

Heat Seal Strength

In order to determine the heat seal strength, two films are laid one on top of the other with their two modified sides and heat-sealed at a temperature of 130° C. and a sealing time of 0.5 sec. and a sealing pressure of 10 N/cm2 in a Brugger HSG/ETK heat-sealing unit. Test strips with a width of 15 mm are cut out of the heat-sealed samples. The two strips are subsequently peeled apart at 200 mm/min by the T-peel method in a tensile testing machine, with the seal seam plane forming a right angle to the direction of tension. The heat seal strength quoted is the force necessary to separate the test strips.

1-11 are cancelled.

12. A coextruded, biaxially oriented polyolefin film for heat-sealing, wherein the film comprises a base layer built up from polyolefinic polymers and at least one outer top layer, wherein said top layer comprises at least 50% by weight, based on the weight of the top layer, of a maleic anhydride-modified polyolefin and has been surface-treated by means of a flame on the surface of the said top layer.

13. The film according to claim 12, wherein said maleic acid content in the modified polyolefin is in the range from 0.05 and 5% by weight, based on the modified polyolefin.

14. The film according to claim 12, wherein said modified polyolefin has a melting point, in accordance with DSC, in the range from 140 to 165° C.

15. The film according to claim 12, wherein said base polyolefin employed for the modification is a propylene homopolymer or propylene-ethylene copolymer or a propylene-ethylene-butylene terpolymer.

16. The film according to claim 15, wherein said propylene-ethylene copolymer as base polyolefin has an ethylene content in the range from 0.5 to 10% by weight.

17. The film according to claim 12, wherein said top layer comprising modified polyolefin is in the range from 0.3 to 3 μm.

18. The film according to claim 12, wherein said top layer comprising modified polyolefin additionally comprises an unmodified polyolefin.

19. The film according to claim 13, wherein said modified polyolefin has a melting point, in accordance with DSC, in the range from 140 to 165° C. and said base polyolefin employed for the modification is a propylene homopolymer or propylene-ethylene copolymer or a propylene-ethylene-butylene terpolymer.

20. The film according to claim 19, wherein said propylene-ethylene copolymer as base polyolefin has an ethylene content in the range from 1 to 5% by weight.

21. The film according to claim 20, wherein said top layer comprising modified polyolefin is in the range from 0.3 to 3 μm

22. The film according to claim 12, wherein said top layer comprising modified polyolefin additionally comprises a propylene homopolymer, a propylene-ethylene copolymer or a propylene-ethylene-butylene terpolymer.

23. The film according to claim 21, wherein said top layer comprising modified polyolefin additionally comprises a propylene homopolymer, a propylene-ethylene copolymer or a propylene-ethylene-butylene terpolymer.

24. The film according to claim 12, wherein the film has a heat seal strength in the range from 1.0 to 2.0 N/15 mm.

25. The film according to claim 23, wherein the film has a heat seal strength in the range from 1.0 to 2.0 N/15 mm.

26. The film according to claim 12, wherein the film has a surface tension after flame treatment is in the range from 39 to 50 mN/m.

27. The film according to claim 25, wherein the film has a surface tension after flame treatment is in the range from 39 to 50 mN/m.

28. The film according to claim 12, wherein the film has a second top layer.

29. The film according to claim 27, wherein the film has a second top layer.

30. The film according to claim 28, wherein the film additionally has an interlayer on one or both sides.

31. The film according to claim 29, wherein said top layer comprises at 95% by weight to less than 100% by weight, based on the weight of the top layer, of a maleic anhydride-modified polyolefin and wherein said modified polyolefin has a melting point, in accordance with DSC, in the range from 155 to 165° C. and and a melt flow index (measurement DIN 53 735 at a load of 21.6 N and 230° C.) of from 1.5 to 6.5 g/10 min and an n-heptane-soluble content of the isotactic propylene homopolymers is from 2-5% by weight, based on the starting polymer.
